(19) United States
(12) Patent Application Publication
(10) Pub. No.: US 2025/0170708 A1
(43) Pub. Date: May 29, 2025

(54) Method for Controlling a Robot

(71) Applicant: Deutsches Zentrum für Luft- und Raumfahrt e.V., Bonn (DE)

(72) Inventors: Jörn Vogel, München (DE); Annette Hagengruber, München (DE)

(21) Appl. No.: 18/837,480

(22) PCT Filed: Feb. 13, 2023
(86) PCT No.: PCT/EP2023/053456

§ 371 Date: Aug. 9, 2024

(30) Foreign Application Priority Data
Feb. 11, 2022 (DE) 10 2022 103 275

(51) Int. Cl. B25J 9/16

(52) U.S. Cl. CPC B25J 9/163; B25J 9/1661

(57) ABSTRACT

The invention relates to a method for controlling a robot, said method including the following method steps: a) detecting a biosignal on a body part of a user; b) deriving a user command (\dot{x}ᵤₛᵣ) for controlling the robot from the detected biosignals; c) deriving a task to be performed from the user command (\dot{x}ᵤₛᵣ) using an intention recognition module; d) calculating an optimal command (\dot{x}ₒₚₜ) which is most efficient for performing the task; e) determining a deviation between the user command (\dot{x}ᵤₛᵣ) and the optimal command (\dot{x}ₒₚₜ); f) adjusting the decoding algorithm, by means of which the user command (\dot{x}ᵤₛᵣ) is decoded from the biosignal, based on the determined deviation; and g) controlling the robot using the adjusted decoding algorithm.

### CROSS-REFERENCE TO RELATED APPLICATIONS

This application is the United States national phase of International Patent Application No. PCT/EP2023/053456 filed Feb. 13, 2023, and claims priority to German Patent Application No. 10 2022 103 275 filed Feb. 11, 2022, the disclosures of which are hereby incorporated by reference in their entireties.

### BACKGROUND OF THE INVENTION

### Field of the Invention

The invention relates to a method for controlling a robot.

### Description of Related Art

Human-machine interfaces, such as brain-computer interfaces (BCI), or interfaces based on the measurement of muscle activity (e.g. EMG) or other biological signals, are often developed today to enable people with disabilities to control technical devices. Typically, these interfaces capture signals from humans and translate them into control signals using an algorithm (decoder), which typically utilises machine learning methods. In order to calibrate the decoder to the specific signals of the user, a training procedure is typically carried out in which the user is asked to generate certain signals. In the example of a BCI, the user is asked to imagine movements of the right hand for a certain period of time and then movements of the left hand. This so-called open-loop training has the disadvantage that the user does not yet take control of the device to be controlled during the generation of these signals. This often results in the signals generated by the user changing as soon as they are used for actual control. To counteract this effect, decoder calibration can be extended to include closed-loop training. In this process, the user is presented with predefined targets, e.g. on a screen, which he or she should control. The decoded control signal can be compared with the desired (optimum) control signal using the known predefined target and the decoder can thus be adapted.

Information on the state of the art can be found in the following publications.
[1] Jarosiewicz, Beata, et al. “Virtual typing by people with tetraplegia using a self-calibrating intracortical brain-computer interface.” Science translational medicine 7.313 (2015): 313ra179-313ra179.
[2] Hochberg, Leigh R., et al. “Reach and grasp by people with tetraplegia using a neurally controlled robotic arm.” Nature 485.7398 (2012): 372-375.
[3] Schiel, Felix, et al. “Incremental learning of EMG-based control commands using Gaussian Processes”. Conference on Robot Learning (CoRL), 2020.

Various methods are known in the state of the art for calibrating biosignal-based interfaces. In addition to the classic open-loop routines, in which the user is requested to generate a specific signal, the closed-loop methods are particularly promising. In closed-loop calibration, an optimum control signal for the current task is typically calculated in addition to the decoded control signal when the interface is used. In order to be able to calculate this optimum control signal, it is necessary to know which task the user wants to perform. Various examples of this are known in the literature. For example, when entering text, BCI can be used to retrospectively determine whether the user has selected the correct letter. For this purpose, it can either be analysed that the user deletes letters that were typed incorrectly, or dictionaries and automatic text completion can be used [1].

When biosignal-based interfaces are used to control robots, closed-loop calibration is typically performed by having the user move to predefined targets in space or command the robot in a specific direction. Since the target of the movement is known in this artificial task, the optimum control command can be determined and used to update the decoder [2].

Alternatively, unsupervised methods can also be used in which assumptions about the correctness of the decoding are only made on the basis of the generated biosignals and the control signals calculated by the decoder. The decoder can then be updated on the basis of these assumptions [3].

### SUMMARY OF THE INVENTION

The object of the invention is to provide an improved method for controlling a robot and, in particular, for updating a decoder using bio-signals.

In accordance with the invention, the problem is solved by a method as described herein.

The method according to the invention for controlling a robot comprises the following method steps:
A Sensing a bio-signal on a part of a user's body
B Derivation of a user command (\dot{x}ᵤₛᵣ) to control the robot from the recorded bio-signals
C Deriving a task to be performed from the user command (\dot{x}ᵤₛᵣ) using an intention recognition module
D calculate an optimal command (\dot{x}ₒₚₜ) that is most efficient to fulfil the task
E Determine a deviation between the user command (\dot{x}ᵤₛᵣ) and the optimal command (\dot{x}ₒₚₜ)
F Adapt the decoding algorithm used to decode the user command (\dot{x}ᵤₛᵣ) from the organic signal on the basis of the deviation determined
G Control the robot using the customised decoding algorithm.

The method according to the invention enables improved control of a robot using bio-signals without having to interrupt the current activity. It is not necessary to carry out separate training tasks in order to improve the decoding algorithm. Rather, the decoding algorithm can be improved during operation.

It is preferable that the robot controller has a description of the task to be performed, which contains geometric or other constraints that are required to fulfil the task. A description may be available, for example, if the robot provides semi-autonomous assistance in performing the task. Such constraints can be in various formats known from the state of the art:
IEEE, “Shared Control Templates for Assistive Robotics”, published Sep. 15,2020 and
IEEE, “Toward Seamless Transitions Between Shared Control and Supervised Autonomy in Robotic Assistance”, published Mar. 3, 2021.

If, for example, a glass is to be gripped by a robot hand, the geometric constraints could take the form of a funnel that runs towards the glass to be gripped or tapers towards it. The geometric constraint would thus define that the robot hand must move closer and closer to the object to be gripped within this funnel. Based on the geometric or other constraints, an optimum control command can then be determined to fulfil the task. If the user command derived from the detected bio-signals results in a movement that leads out of the funnel or deviates from this optimal command in any other way, the decoding algorithm can be adapted accordingly by deriving a user command from the same bio-signals that remains within the funnel, i.e. that fulfils the geometric constraints of the task to be performed. The underlying assumption is that the user actually intends to generate this optimal control command, as he wants to perform the task. However, if the decoder does not generate this optimal command, it may be necessary to adapt the decoder in order to generate the optimal command in the current situation.

It is preferable that the user command is modified by adapting the decoding algorithm so that the task can be performed more efficiently.

The decoding algorithm can be adapted according to process step f in real time during operation. In this case, the user will not or hardly notice the improvement in the decoding algorithm, as the ongoing operation of the robot is not interrupted and the decoding algorithm is changed in small steps.

Alternatively, it is possible to use the improved decoding algorithm at a later point in time, while the robot is controlled in real time on the basis of the original decoding algorithm. In other words, the improved decoding algorithm is not used immediately in real time, but only in a later application, e.g. in the next task to be executed.

It is also preferable that the user command is derived from the bio-signals using a Gaussian process regression method.

Furthermore, it is preferred that the adaptation of the decoding algorithm according to method step f is additionally carried out on the basis of regression parameters provided by the decoding algorithm.

It is further preferred that the bio-signals are EMG signals. Alternatively or additionally, muscle signals measured using other suitable measurement principles can be used and/or signals of the peripheral nervous system or signals of the central nervous system, in particular of the brain, which are measured non-invasively or invasively (EEG, MEG, NIRS, FMRI, ECOG, multi-electrode arrays).

Preferred embodiments of the invention are explained below with reference to figures.

### BRIEF DESCRIPTION OF THE DRAWINGS

The terms Fig., Figs., Figure, and Figures are used interchangeably to refer to the corresponding figures in the drawings.

FIG. 1 shows a possible application scenario for the method according to the invention

FIG. 2 shows the sequence of an embodiment of the method according to the invention

### DESCRIPTION OF THE INVENTION

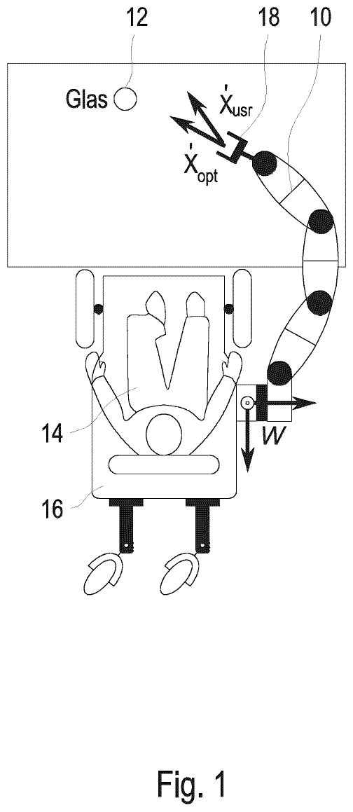

According to FIG. 1, a user (14) controls a robotic arm (10) using EMG signals. The EMG signals can be recorded on a part of the user's body using suitable sensors. This can be done on the user's forearm, for example.

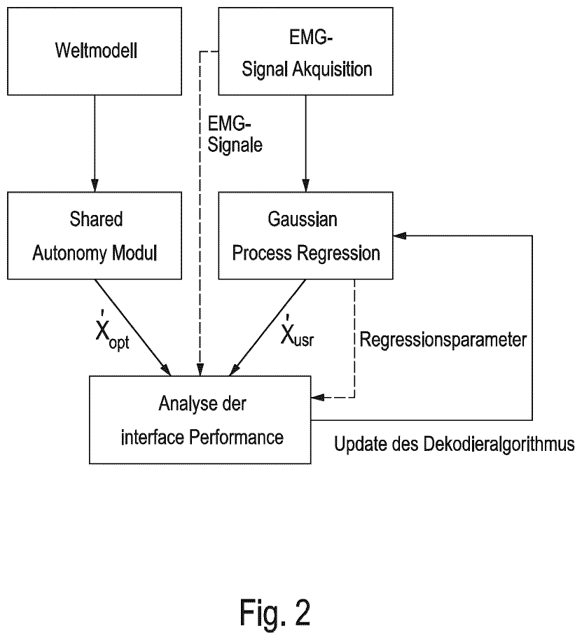

As shown in FIG. 2, the recorded EMG signals are used to derive a user command (\dot{x}ᵤₛᵣ) is derived.

As shown in FIG. 1, this user command (\dot{x}ᵤₛᵣ) may be suboptimal for the task to be performed because, for example, it does not fulfil the geometric constraints that must be met to perform the task.

Knowing the task to be performed, an optimal command (\dot{x}ₒₚₜ) can be calculated which would lead to the most efficient fulfilment of the task in the current world state. This optimum command (x\dot{x}ₒₚₜopt) would guide the gripper (18) along the shortest path to the glass (12).

According to the invention, the decoding algorithm is updated (see FIG. 2) so that the decoding algorithm is updated on the basis of the deviation between the user command (\dot{x}ᵤₛᵣ) and the optimum command (\dot{x}ₒₚₜ) is adapted. Further regression parameters provided by the decoding algorithm can be taken into account here. This can include, for example, the confidence of the algorithm with regard to decoding or the recorded EMG signals. Based on this data, an update for the model of the decoding algorithm can then be calculated and implemented. The implementation can take place during operation or at a later point in time.

1. A method controlling a robot, comprising the following method steps:
A Sensing a bio-signal on a part of a user's body
B Derivation of a user command (\dot{x}ᵤₛᵣ) to control the robot from the recorded bio-signals
C Deriving a task to be performed from the user command (\dot{x}ᵤₛᵣ) using an intention recognition module
D calculate an optimal command (\dot{x}ₒₚₜ) that is most efficient to fulfil the task
E Determine a deviation between the user command (\dot{x}ᵤₛᵣ) and the optimal command (\dot{x}ₒₚₜ)
F Adapt the decoding algorithm used to decode the user command (\dot{x}ᵤₛᵣ) from the organic signal on the basis of the deviation determined
G Control the robot using the customised decoding algorithm.

2. The method for controlling a robot according to claim 1, wherein the robot controller has a description of the task to be performed, which contains geometric or other constraint conditions which are required to perform the task.

3. The method for controlling a robot according to claim 1, wherein, by adapting the decoding algorithm, the user command (\dot{x}ᵤₛᵣ) is generated in such a way that a more efficient execution of the task is made possible.

4. The method for controlling a robot according to claim 1, wherein the robot is controlled according to method step f in real time during operation.

5. The method for controlling a robot according to claim 1, wherein the control of the robot according to method step f takes place at a later point in time, while in real time the control of the robot takes place without adaptation of the decoding algorithm.

6. The method for controlling a robot according to claim 1, wherein the derivation of the user command (\dot{x}ᵤₛᵣ) is derived from the bio-signals using a Gaussian process regression method.

7. The method for controlling a robot according to claim 6, wherein the adaptation of the decoding algorithm according to method step f takes place on the basis of regression parameters which are provided by the decoding algorithm.

8. The method for controlling a robot according to claim 1, wherein the bio-signals are EMG signals.
